(19) United States
(12) Patent Application Publication
(10) Pub. No.: US 2006/0271396 A1
(43) Pub. Date: Nov. 30, 2006

(54) Method of certificating message, terminal thereof and system thereof

(76) Inventors: Seung Jae Lee, Gwangmyeong-si (KR); Yeon Lae Lim, Seoul (KR)

Correspondence Address: MCKENNA LONG & ALDRIDGE LLP;Song K. Jung, 1900 K Street, N.W., Washington, DC, 20006, US

(21) Appl. No.: 11/442,255

(22) Filed: May 30, 2006

(30) Foreign Application Priority Data
May 27, 2005 (KR) 10-2005-0045001

(51) Int. Cl. G06Q 99/00

(52) U.S. Cl. 705/1

(57) ABSTRACT

A method of certificating a message, terminal thereof and system thereof are disclosed. By the present invention, in transmitting various messages via a prescribed communication service, a validity of the message is certificated. By the present invention, without checking contents of a message, a recipient can confirm whether a received message is sent from a valid originator or whether the received message is a valid message.

This application claims the benefit of the Korean Patent Application No. P200X-XXXXX, filed on YYYY ZZ, 200X, which is hereby incorporated by reference for all purposes as if fully set forth herein.

### BACKGROUND OF THE INVENTION

1. Field of the Invention

The present invention relates to the transmission of messages, and more particularly, to a method of certifying messages, and a terminal and system for sending same.

2. Discussion of the Related Art

Due to the increased cover and popularity of mobile communication networks, the number of calls made using mobile communication terminals continues to increase such that they may out number calls made using conventional wired systems.

Most mobile communication terminals include functionality which allows a user to transmit text or multimedia messages in addition to voice communication functionality. These messages are transmitted using various services, such as short message service (SMS), a long message service (LMS), an enhanced message service (EMS), a multimedia message service (MMS) and the like, which provide standardized protocols for transmitting text and/or multimedia messages over a wireless communications network.

The use of these messaging service continues to increase due to the wide spread use of wireless communications.

Furthermore, with the advent of the fast information-oriented society, personal information is frequently disclosed via Internet. For example, personal information of mobile communication subscribers is open to public. As a result, users are receiving unnecessary spam mail or voice communications in their mobile communication terminals.

With unwanted voice communications, a user can manually filter out the unwanted voice communications using a supplementary service such as a caller identification number display service. However, mobile terminals are unable to filter out unwanted or unlawful messages received via the various non-voice messaging services, (e.g., SMS, LMS, EMS, MMS, etc.). More specifically, current mobile communication systems are unable to confirm whether a message or the sender of the message is valid or not.

As a result, a user can only confirm whether a received message is valid or unnecessary after reading the message. As a shortcut, users generally manually filter their messages by determining who the message is from before they read the entire message.

However, if an originator manipulates the caller information transmitted with a message, a recipient will be unable to filter the message using the conventional methods.

### SUMMARY OF THE INVENTION

Accordingly, the present invention is directed to a method of certifying messages, and a terminal and system for sending same that substantially obviates one or more problems due to limitations and disadvantages of the related art.

An advantage of the present invention is that it provides a method of certifying transmitted messages.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these objects and other advantages and in accordance with the purpose of the invention, as embodied and broadly described, there is provided

In another aspect of the present invention, there is provided a method of certifying transmitted messages in a telecommunication system, the method comprising: receiving a certificated message from a calling terminal, the certificated message including a certification code and a message; determining whether the certification code is valid; and relaying the message to a called terminal if the certification is determined to be valid.

In another aspect of the present invention, there is provided a method of certifying transmitted messages in a telecommunication system, the method comprising: receiving a certificated message from a calling terminal, the certificated message including a certification code and a message; relaying the certificated message to a called terminal; determining whether the certification code is valid; and revoking the certificated message if the certification code is determined to be invalid.

In another aspect of the present invention, there is provided a method of certifying transmitted messages in a telecommunication system, the method comprising: receiving a certificated message from a calling terminal, the certificated message including a certification code and a message; relaying the message to a called terminal; determining whether the certification code is valid; and sending a decryption key to the called terminal if the certification code is valid.

In another aspect of the present invention, there is provided a method of certifying transmitted messages in a telecommunication system, the method comprising: receiving a certificated message from a calling terminal, the certificated message including a certification code and a message; relaying the certificated message to a called terminal; determining whether the certification code is valid; and transmitting a signal to the called terminal, the signal indicating whether or not the certification code is valid. In another aspect of the present invention, there is provided a method of certifying transmitted messages in a telecommunication system, the method comprising: receiving a message from a calling terminal; requesting from the calling terminal a certification code for certifying the calling terminal; receiving the certification code and determining whether or not the certification code is valid; and relaying the message to a called terminal if the certification code is valid.

In another aspect of the present invention, there is provided a telecommunication system for certifying transmitted messages, said system comprising: first receiver receiving a certificated message from a calling terminal, the certificated message including a certification code and a message; processor determining whether the certification code is valid; and transmitter relaying the message to a called terminal if said processor determines that the certification code is valid.

In another aspect of the present invention, there is provided in a telecommunication system, a server certifying transmitted messages, said server comprising: means for receiving a certificated message from a calling terminal, the certificated message including a certification code and a message; means for determining whether the certification code is valid; and means for relaying the message to a called terminal if said processor determines that the certification code is valid.

In another aspect of the present invention, there is provided a telecommunication system for certifying transmitted messages, said system comprising: receiver receiving a certificated message from a calling terminal, the certificated message including a certification code and a message; transmitter relaying the certificated message to a called terminal; processor determining whether the certification code is valid; and means for revoking the certificated message if the certification code is determined to be invalid.

In another aspect of the present invention, a telecommunication system for certifying transmitted messages, said system comprising: receiver receiving a certificated message from a calling terminal, the certificated message including a certification code and a message; transmitter relaying the message to a called terminal; and processor determining whether the certification code is valid, wherein said transmitter sends a decryption key to the called terminal if the certification code is valid.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 is a diagram of an exemplary communication system in which a message certification method according to a first embodiment of the present invention may be employed;

FIG. 2 is a diagram of an exemplary communication system in which a message certification method according to a second embodiment of the present invention may be employed;

FIG. 3 is a diagram of an exemplary communication system in which a message certification method according to a third embodiment of the present invention may be employed;

FIG. 4 is a flowchart of a method for transmitting messages according to a first embodiment of the invention;

FIG. 5 is a flowchart of a method for transmitting messages according to a second embodiment of the invention;

FIG. 6 is a flowchart of a method for transmitting messages according to a third embodiment of the invention; and

FIG. 7 is a flowchart of a method for transmitting messages according to a fourth embodiment of the invention.

### DETAILED DESCRIPTION OF THE INVENTION

Reference will now be made in detail to embodiments of the present invention, examples of which are illustrated in the accompanying drawings. Wherever possible, the same reference numbers will be used throughout the drawings to refer to the same or like parts.

A user message as defined by the present invention includes any text or multimedia message transmitted via a message communication service as SMS, LMS, EMS, MMS and the like.

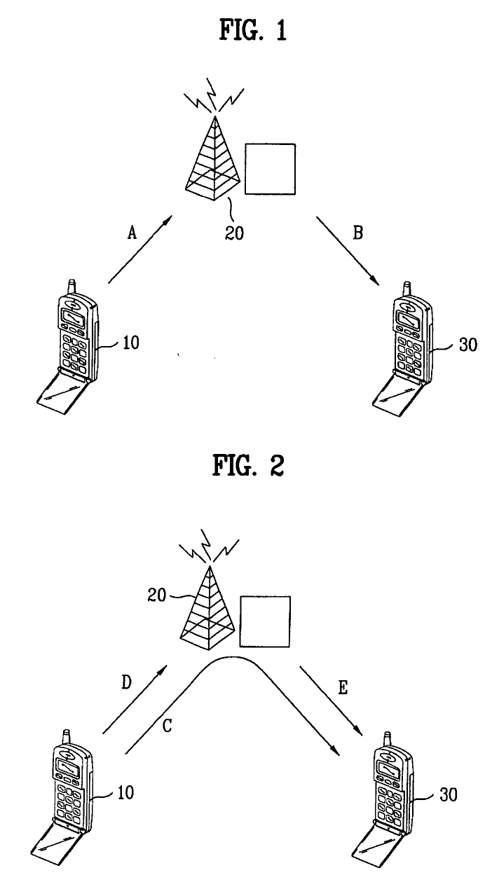

FIG. 1 is a block diagram of an exemplary communication system in which a message certification method according to a first embodiment of the present invention may be employed. As shown in FIG. 1, the communication system includes a calling terminal 10, a called terminal 30, and a server 20 which transmits or relays messages from the calling terminal 10 the called terminal 30.

Although the calling and called terminals 10 and 30 are illustrated as mobile terminals any mobile device capable of transmitting and receiving messages may be employed. In addition, in the description below various functionality is discussed with regard to the calling terminal and the called terminal, however, each terminal may include both the calling and called terminal functionality.

The calling terminal 10 includes a first menu for a user or message originator to generate a user message. The calling terminal 10 also includes a second menu to grant a prescribed certification code to the message generated by the originator via the first menu.

The calling terminal 10 also includes a third menu to transmit the message (referred to as a certificated message) certificated by granting the certification code to the user message via the second menu. The calling terminal 10 further includes a processor to generate a certificated message by granting the certification code to the user message according to the execution of the second menu.

Therefore, the calling terminal 10 grants the certification code to the user message through the above-explained menu configurations and then sends the generated certificated message to a called number inputted by the originator. The aforesaid certificated message or a certificated message described in the following is a message to which the certification code of the present invention is granted.

In the above description, the calling terminal 10 is operating in a certification mode in case of granting the certification code to the user message. In the certification mode, the second menu of the calling terminal 10 is operative. In contrast, if the originator requests a normal mode instead of the certification mode, the second menu is not operative. In normal mode, the third menu sends a user message generated via the first menu instead of sending the certificated message. Operation in the certification mode is explained as follows.

First of all, the calling terminal 10 generates the certificated message via the processor in case that the originator requests a grant of the certification code via the second menu.

The server 20 selectively relays the certificated message sent by the calling terminal 10 to the called terminal 30 of the corresponding called number. Before relaying the certificated message, the server 20 extracts the certification code from the certificated message and preferably verifies the validity of the certification code.

The server 20 then selectively relays the user message based on the verification of the certification code. Specifically, if the certification code from the certificated message is valid, the server 20 extracts the user message from the certificated message and sends the extracted user message to the called terminal 30. On the other hand, if the certification code is not valid, the server 20 revokes the certificated message and does not send the corresponding user message of the received certificated message.

By revoking the certificated message, the server 20 may revoke the received certificated message and notify the calling terminal 10 of the revocation, and/or notify the calling terminal 10 that an update or modification of the certification code is needed.

As a result, the called terminal 30 only receives user messages from the server 20 that have been verified by the server. Furthermore, the called terminal does not receive the certification code granted by the calling terminal 10 because it is removed and only the user message is received by the called terminal 30.

Exemplary methods for the server 20 to verify the validity for the certification code granted to the certificated message are explained below.

According to a first verification method, the server 20 retains a code for the calling terminal previously registered by the calling terminal 10 or the originator. The server 20 compares the previously registered code to the certification code extracted from the certificated message received from the calling terminal 10.

The server 20 decides that the certification code granted to the certificated message is valid if the above two codes (the code for the calling terminal and the certification code granted to the certificated message) coincide with each other, otherwise the certificated message is invalid.

The code for the calling terminal or the certification code is an identification code uniquely granted to the calling terminal 10 or the originator. For example, the identification code may be a mobile identification number (MIN), an electronic serial number (ESN), a mobile equipment identifier (MEID), an international mobile subscriber identity (IMSI) or the like. However, the identification code is not limited to one of the MIN, ESN, MEID and IMSI but may include any code that can be uniquely granted to the calling terminal 10 or the originator.

For example, the identification code may be an arbitrary code previously registered with the server 20 by the originator. In particular, the present invention uses an social identification number of the originator as the code. Specifically, the social identification number of the originator is used as the code of the present invention in part or entirely.

According to a second verification method, the server 20 retains a code for a called terminal previously registered by the called terminal 30, and the server 20 compares the previously registered code for the called terminal to the certification code extracted from the certificated message received from the calling terminal 10.

The server 20 decides that the certification code granted to the certificated message is valid if the above two codes (the code for the called terminal and the certification code granted to the certificated message) coincide with each other.

The code for the called terminal or the certification code is an identification code uniquely granted to the called terminal 30 or a user (hereinafter called a recipient) of the called terminal 30. For example, the identification code may be a mobile identification number (MIN), an electronic serial number (ESN), a mobile equipment identifier (MEID), an international mobile subscriber identity (IMSI) or any other code that can be uniquely granted to the called terminal 30.

In addition, the code for the called terminal or the certification code may be an arbitrary code previously registered to the server 20 by the recipient. In particular, the present invention uses a social identification number of the recipient as the code. Specifically, the social identification number of the recipient is used as the code of the present invention in part or entirely.

According to a third verification method, the certification code is a digital electronic signature using either a certificate of the calling terminal 10 or a certificate of the originator. Alternatively, the certification code is a digital electronic signature using either a certificate of the called terminal 30 or a certificate of the recipient. The certificates are public key based certificates used in the public key based structure.

The server extracts the certification code from the certificated message received from the calling terminal 10, and inquires of an online certificate status protocol (OCSP) responder about the extracted certification code (digital electronic signature using a certificate). The OCSP responder confirms whether the certification code is valid and then answers a corresponding confirmation result in response.

The server 20 then determines the validity of the certification code (digital electronic signature using a certificate) based on the response of the OCSP responder. For example, if an affirmative response is received from the OCSP responder, the server 20 decides that the certification code is valid. Otherwise, the sever 20 decides that the certification code is invalid.

According to a fourth verification method, the server 20 retains a certificate revocation list (CRL), which is periodically updated, and the server 20 compares the extracted certification code to the CRL. For example, certification codes may be added to the list after at predetermined amount of time, or upon expiration of a specified amount of time after registration.

The certification code is a digital electronic signature using either a certificate of the calling terminal 10 or a certificate of the originator. Alternatively, the certification code is a digital electronic signature using either a certificate of the called terminal 30 or a certificate of the recipient. The certificates are public key based certificates used in the public key based structure.

The server 20 determines the validity of the certification code (digital electronic signature using a certificate) according to whether the certificate of the extracted certification code is included in the CRL. For example, if the certificate of the extracted certification code is included in the CRL, the server 20 decides that the certification code from the certificated message received from the calling terminal 10 is invalid.

FIG. 2 is a block diagram of an exemplary communication system in which a message certification method according to a second embodiment of the present invention may be employed. As shown in FIG. 2, the communication system includes a calling terminal 10, a called terminal 30, and a server 20 which transmits or relays certificated messages from the calling terminal 10 the called terminal 30.

The calling terminal 10 includes a first menu for an originator to generate a user message, and a second menu to grant a certification code to the user message generated by the originator via the first menu. The calling terminal 10 also includes a third menu to transmit a certificated message generated by granting the certification code to the user message via the second menu, and a fourth menu to transmit the certification code granted to the user message via the second menu.

In addition, the calling terminal 10 includes a processor to generate a certificated message by granting the certification code to the user message according to the execution of the second menu.

Therefore, the calling terminal 10 grants the certification code to the user message through the above-explained menu configurations and then sends the generated certificated message to a called number inputted by the originator. The calling terminal 10 then sends the certification code granted to the certificated message to the server 20.

In the above description, in case that the calling terminal 10 grants the certification code to the user message, it means that the originator requests a certification of the user message generated via the first menu. According to the originator's certification request, the calling terminal 10 operates in a certification mode.

In the certification mode, the second and fourth menus of the calling terminal 10 are operative. In contrast, in case that the originator requests a normal mode instead of the certification mode, the second and fourth menus are not operative. In case of the normal mode, the third menu sends a user message generated via the first menu instead of sending the certificated message. The operation in the certification mode is explained below.

First, the calling terminal 10 generates a certificated message via the processor in case that the originator requests a grant of the certification code via the second menu. Then the server 20 relays the certificated message sent by the calling terminal 10 to the called terminal 30 of the corresponding called number.

The server delivers the certificated message received from the calling terminal to the called terminal 30 and verifies a presence or non-presence of validity for the certification code received from the calling terminal 10.

The server 20 sends a verification result of the validity for the certification code to the called terminal 30. As mentioned in the foregoing description, the server 20 sends the verification result of validity for the certification code to the calling terminal 10 according to the implementation of the system.

If the certification code received from the calling terminal 10 is valid, the server sends a decryption key, which is to be used in decoding the user message from the certificated message, to the called terminal 30. On the other hand, if the received certification code is invalid, the server orders the called terminal 30 to revoke the certificated message received as the verification result. The server 20 may also notify the calling terminal 10 that an update or modification of the certification code is needed.

The called terminal 30 decodes the user message from the certificated message received from the server 20 using the received decryption key and displays contents of the decoded user message via a display means. In particular, the called terminal 30 decrypts the certification code granted to the previously received certificated message using the decryption key received from the server 20. If so, the certification code is removed from the certificated message and the user message is then extracted as a decryption result. Subsequently, the called terminal 30 displays contents of the extracted message.

The various verification methods discussed above with regard to the first embodiment may also be employed in the second embodiment and therefore for brevity are not discussed again here.

Alternatively, instead of the server 20 sending a decryption key, the server 20 may send a verification result indicating the validity for the certification code to the called terminal 30. According to implementation of the system, the server 20 may also send the verification result for the certification code to the calling terminal 10.

The verification result sent to the called terminal 30 may be a message or phrase indicating that the certification code for the user message is valid or invalid. The server 20 may also notify the calling terminal 10 that an update or modification of the certification code is needed if the certification code for the user message is invalid.

The called terminal 30 displays the verification result received from the server 20 via a display means. Thereafter, if the recipient requests a display of the received user message by operating the called terminal 30, the called terminal 30 displays contents of the corresponding user message via the display means. Generally, in case that the phrase indicating that the certification code for the user message is valid is displayed, the recipient requests the display of the received user message.

In contrast, if the recipient requests a revocation of the received user message by operating the called terminal 30, the called terminal 30 deletes the corresponding user message. Generally, if a phrase indicating that the certification code for the user message is invalid is displayed, the recipient requests revocation of the received user message.

Again, the various verification methods discussed above with respect to the first embodiment may be employed in the present embodiment as well.

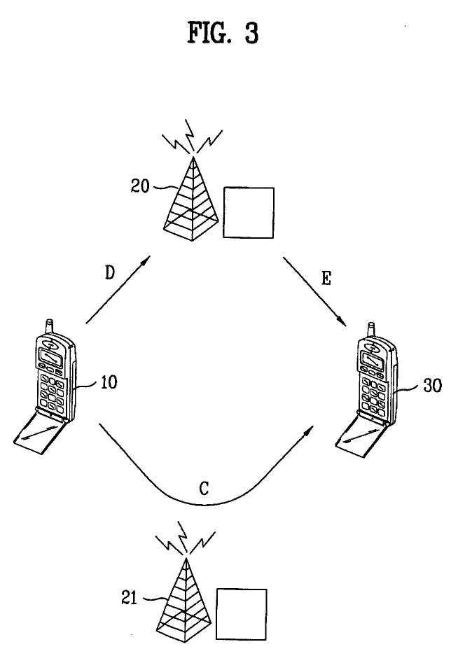

FIG. 3 is a block diagram of an exemplary communication system in which a message certification method according to a third embodiment of the present invention may be employed. As shown in FIG. 3, the communication system includes a calling terminal 10, a called terminal 30, a server 20 receiving a certification code for message certification from the calling terminal 10, and a relay server 21 receiving a message sent from the calling terminal 10 to relay to the called terminal 30.

The calling terminal 10 includes a first menu for an originator to generate a prescribed user message, and a second menu to grant a prescribed certification code to the user message generated by the originator via the first menu.

The calling terminal 10 also includes a fourth menu to transmit the certification code granted to the user message via the second menu to the server 20.

In addition, the calling terminal 10 includes a processor to generate a certificated message by granting the certification code to the user message according to the execution of the second menu.

Therefore, the calling terminal 10 grants the certification code to the user message through the above-explained menu configurations and then sends the generated certificated message to a called number inputted by the originator. The calling terminal 10 also sends the certification code granted to the certificated message to the server 20.

In the above description, in case that the calling terminal 10 grants the certification code to the user message, it means that the originator requested certification of the user message generated via the first menu. According to the originator's certification request, the calling terminal 10 operates in a certification mode.

In the certification mode, the second and fourth menus of the calling terminal 10 are operative. In contrast, in case that the originator requests a normal mode instead of the certification mode, the second and fourth menus are not operative. In case of the normal mode, a third menu sends the user message generated via the first menu instead of sending the certificated message. The operation in the certification mode is explained below.

First of all, the calling terminal 10 generates the certificated message via the processor in case that the originator requests a grant of the certification code via the second menu. Then the relay server 21 relays the certificated message sent by the calling terminal 10 to the called terminal 30 of the corresponding called number.

Server 20 verifies the presence or non-presence of validity for the certification code received from the calling terminal 10. The certification code may automatically be sent to the server 20 from the calling terminal or the calling terminal may wait for a request from the server 20 before sending the certification code. The server 20 then sends a verification result of the validity for the certification code to the called terminal 30. According to the implementation of the system, the server 20 may also send the verification result of validity for the certification code to the calling terminal 10 as well.

If the certification code received from the calling terminal 10 is valid, the server 20 sends a decryption key, which is to be used as the verification result in decoding the user message from the certificated message, to the called terminal 30.

On the other hand, if the received certification code is invalid, the server 20 orders the called terminal 30 to revoke the certificated message received as the verification result. The server 20 may also notify the calling terminal 10 that an update or modification of the certification code is needed.

The called terminal 30 decodes the user message from the certificated message received from the relay server 21 using the decryption key received from the server 20 and then displays the contents of the decoded user message via a display means. In particular, the called terminal 30 decrypts the certification code granted to the certificated message previously received from the relay server 21 using the decryption key received from the server 20. Then the certification code is removed from the certificated message and the user message is extracted as a decryption result. Subsequently, the called terminal 30 displays contents of the extracted message.

The various verification methods discussed above with regard to the first embodiment may also be employed in the third embodiment and therefore for brevity are not discussed again here.

Alternatively, according to the third embodiment of the invention, instead of the server 20 sending a decryption key, the server 20 may send a verification result of the validity for the certification code to the called terminal 30. According to implementation of the system, the server 20 may send the verification result for the certification code to the calling terminal 10 as well.

The verification result sent to the called terminal 30 may be a message or phrase indicating that the certification code for the user message is valid or invalid. The server 20 may also notify the calling terminal 10 that an update or modification of the certification code is needed if the certification code for the user message is invalid.

The called terminal 30 displays the verification result received from the server 20 via a display means. Therefore, the called terminal 30 receives the user message delivered from the relay server 21 and also receives information indicating the presence or non-presence of the originator and/or the presence or non-presence of the user message as the verification result delivered from the relay server 21 in receiving the user message.

Thereafter, if the recipient requests a display of the received user message by operating the called terminal 30, the called terminal 30 displays contents of the corresponding user message via the display means. Generally, in case that the phrase indicating that the certification code for the user message is valid is displayed, the recipient requests the display of the received user message.

In contrast, if the recipient requests a revoke of the received user message by operating the called terminal 30, the called terminal 30 deletes the corresponding user message. Generally, in case that the phrase indicating that the certification code for the user message is invalid is displayed, the recipient requests the revoke of the received user message.

Again, the various verification methods discussed above with regard to the first embodiment may also be employed in the third embodiment.

Hereinafter, based on the system configurations according to the aforesaid various embodiments of the present invention, a message certificating procedure in the mobile communication system in transmitting various messages via a mobile communication service is explained in detail.

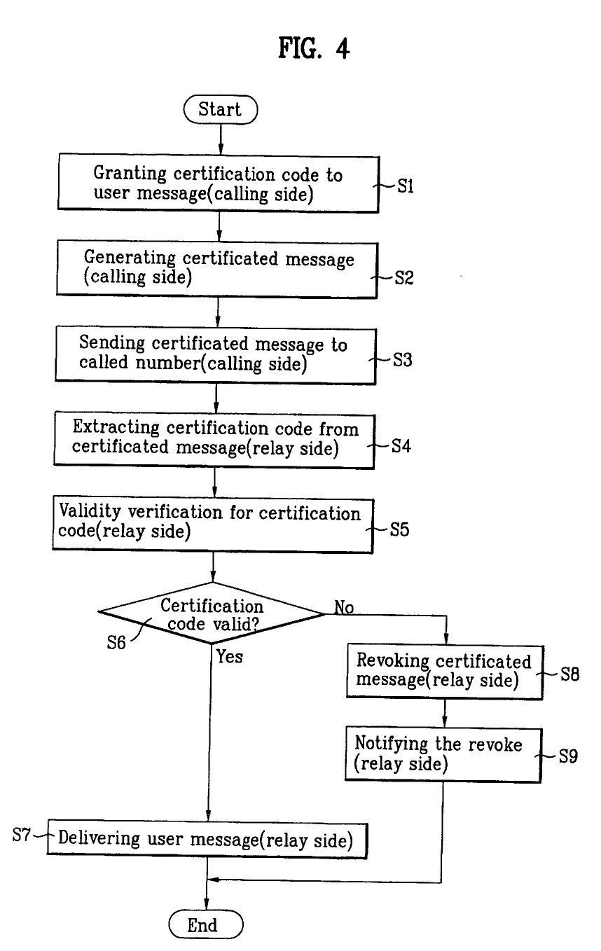

FIG. 4 is a diagram of a message certificating procedure based on the system in FIG. 1. In FIG. 4, a calling side corresponds to a calling terminal, a called side corresponds to a called terminal, and a relay side corresponds to a server.

As shown in FIG. 4, in response to an originator's request to generate a certificated message, the calling side grants a certification code to the user message generated by the originator (S1). The certification code is a predefined unique identifier associated with the originator or the calling terminal.

The granted certification code is a code entered in a code input window by the originator. And, the user message includes one of an SMS message, an LMS message, an EMS message and an MMS message.

Then calling side applies the granted certification code to the originator's message. In other words, the calling side generates a certificated message using the granted certification code (S2). Hence, the certificated message includes the user message generated by the originator and the certification code.

As the originator enters a phone number or address of the called side in a called number input window, the calling side sends the certificated message having the originator certification applied thereto to the corresponding called number (S3). In this case, the sent certificated message follows a message format of SMS, LMS, EMS or MMS.

The relay side extracts the certification code granted to the certificated message received from the calling side (S4). Then the relay side verifies the validity of the extracted certification code (S5) using for example any one of the verification methods discussed above.

If it is verified that the certification code of the received certificated message is valid (Yes path out of S6), the relay side delivers the user message excluding the certification code used in the validity verification to the called side (S7).

In contrast, if it is verified that the certification code of the received certificated message is invalid (NO path out of S6), the relay side revokes the corresponding received certificated message (S8), and notifys the revoke of the certificated message to the calling side (S9). In addition, after completion of the revoke, the relay side may notify the calling side that an update or modification of the certification code is needed (not shown).

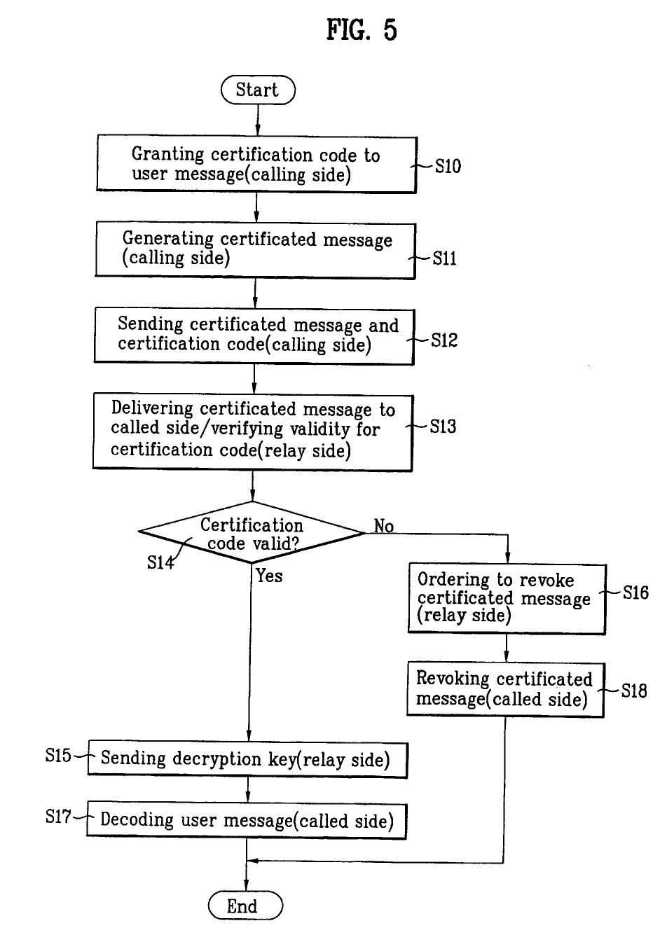

FIG. 5 is a diagram of a message certificating procedure based on the system in FIG. 2. In FIG. 5, a calling side corresponds to a calling terminal, a called side corresponds to a called terminal, and a relay side corresponds to a server.

As shown in FIG. 5, in response to an originator requesting a certificated message, a predetermined certification code is granted to a user message generated by the originator (S10). The granted certification code may be a code entered in a code input window by the originator, and the user message may be one of an SMS message, an LMS message, an EMS message and an MMS message.

The calling side then generates a certificated message using the granted certification code (S11). Hence, the certificated message includes the user message generated by the originator and the certification code.

As the originator enters a phone number or address of the called side in a called number input window, the calling side sends the generated certificated message to the corresponding called number. In this case, the sent certificated message follows a message format of SMS, LMS, EMS or MMS.

Hence, the calling side sends the certification code entered in the code input window by the originator and the certificated message generated using the certification code to the relay side (S12). The relay side delivers the certificated message received from the calling side to the called side of the corresponding called number and verifies the validity of the certification code received from the calling side (S13) using for example one of the various verification methods describe above.

If the certification code received from the calling side is determined to be valid (YES path out of S14), the relay side sends a decryption key to be used in decoding the user message from the certificated message as the verification result to the called side (S15). The called side decodes the user message from the previously received certificated message using the verification result received from the relay side, and displays the contents of the decoded user message via a display means (S17).

Alternatively, if the certification code received from the calling side is determined to be invalid (NO path out of S14), the relay side orders the called side to revoke the certificated message as the verification result (s16) and may notify the calling side that an update or modification of the certification code is needed (not shown). The called side revokes the previously received certificated message based on the verification result received from the relay side (S18) and notifies the relay side of the revoke of the certificated message (not shown).

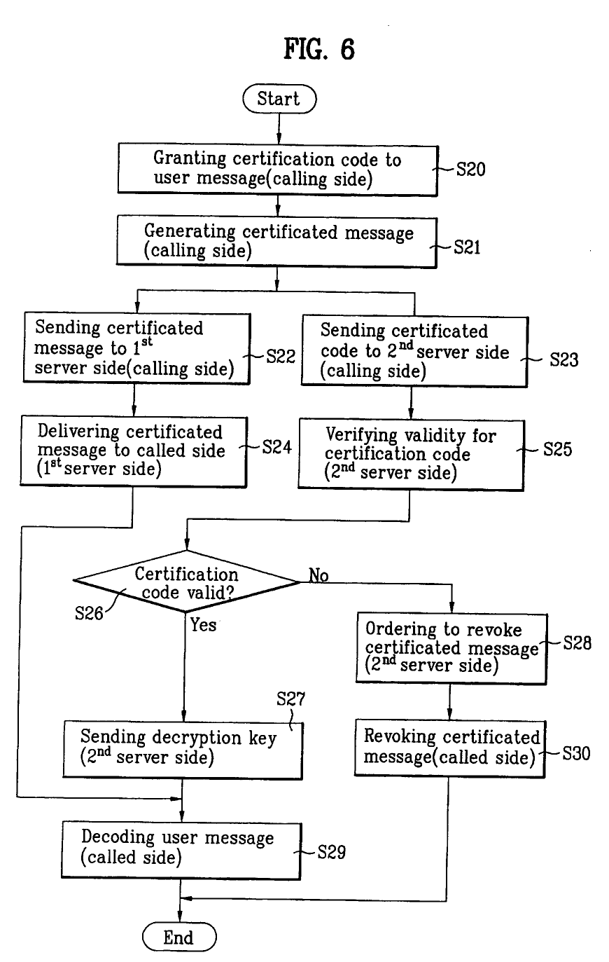

FIG. 6 is a diagram of a message certificating procedure based on the system in FIG. 3. In FIG. 6, a calling side corresponds to a calling terminal, a called side corresponds to a called terminal, a first server side corresponds to a relay server relaying a message, and a second server side corresponds to a server verifying a certification code.

As shown in FIG. 6, in response to an originator requesting a certificated message, the calling side grants a certification code to the user message generated by the originator (S20). The granted certification code may be a code entered in a code input window by the originator, and the user message may include one of an SMS message, an LMS message, an EMS message and an MMS message.

Then, the calling side generates a certificated message using the granted certification code (S21). Hence, the certificated message includes the user message generated by the originator and the certification code entered by the originator.

In response to the originator entering a phone number or address of the called side in, for example, a called number input window, the calling side sends the generated certificated message to the corresponding called number via a first server side (S22). Substantially, simultaneously, the calling side sends the certification code granted to the certificated message to a second server side (S23). Therefore, the calling side sends the certification code entered in the code input window by the originator and the certificated message generated using the certification code to the different server sides, respectively.

The first server side sends the certificated message received from the calling side to the called side of the corresponding called number (S24). The second server side verifies the validity of the certification code received from the calling side (S25) using for example of the four verification methods discussed above.

After completion of the verification of the validity for the certification code, the second server side sends a verification result of the validity for the certification code to the called side (S26). According to implementation of the system, the second server side may send the verification result of the validity for the certification code to the calling side as well.

If the certification code received from the calling side is determined to be valid (YES path of S26), the second server side sends a decryption key to be used in decoding the user message from the certificated message as the verification result to the called side (S27). The called side decodes the user message from the previously received certificated message using the verification result received from the second server side (S29), and, displays the contents of the decoded user message via a display means (not shown).

Alternatively, if the certification code received from the calling side is determined to be invalid (NO path out of S26), the second server side orders the called side to revoke the certificated message as the verification result and notifies the calling side that an update or modification of the certification code is needed (S28). The called side revokes the previously received certificated message based on the verification result received from the second server side (S30), and may notify the second server side of the revoke of the certificated message (not shown).

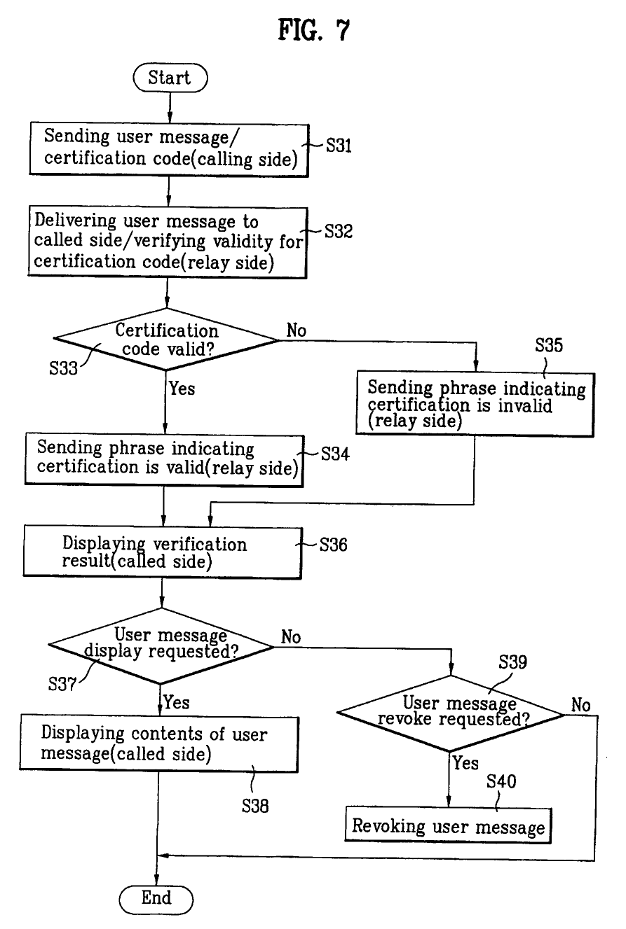

FIG. 7 is a diagram of a message certificating procedure according to a fifth embodiment of the present invention. In FIG. 7, a calling side corresponds to a calling terminal, a called side corresponds to a called terminal, and a relay side corresponds to a server.

As shown in FIG. 7, in response to an originator requesting a certificated message, the calling side links a certification code entered in the code input window by the originator to the user message generated by the originator and then sends them to a relay side (S31). The relay side delivers the user message received from the calling side to the called side of the corresponding called number, and then verifies the validity for the certification code received from the calling side (S32) using for example, one of the various verification methods discussed above.

After completion of the verification of the validity for the certification code, the relay side sends a verification result (a presence or non-presence of coincidence between the compared codes) of the validity for the certification code to the called side. According to implementation of the system, the relay side may send the verification result of the validity for the certification code to the calling side as well.

If the certification code received from the calling side is determined to be valid (YES path out of S33), the relay side sends a message or phrase indicating that the certification code is valid to the called side (S34). Alternatively, if the certification code received from the calling side is determined to be invalid (NO path out of S33), the relay side sends a phrase indicating that the certification code is in valid to the called side (S35). The relay side may also notify the calling side that an update or modification of the used certification code is needed (not shown).

The called side displays the verification result received from the relay side via a display means (s36). Thereafter, if the recipient requests a display of the user message based on the displayed verification result (YES path out of S37), the called side displays contents of the corresponding user message via the display means (S38). Alternatively (NO path out of S37), if the recipient requests a revoke of the user message based on the displayed verification result (YES path out of S39), the called side revokes the corresponding user message (S40).

A configuration of a terminal for message certification in a mobile communication system according to the present invention is explained in detail as follows.

A terminal according to a first embodiment of the present invention includes a transmitting block certificating a message to transmit and a receiving block receiving a message. The transmitting block includes a first block for generating certificated messages by granting a predetermined certification code to a user message generated by an originator and a second block for transmitting the certificated message generated by the first block.

The receiving block includes a third block for receiving the user message, of which prescribed certification code is decoded, from a server and a fourth block for displaying the received user message.

A terminal according to a second or third embodiment of the present invention includes a transmitting block for certificating a message to transmit and a receiving block for receiving a message. The transmitting block includes a first block for generating certificated messages by granting a predetermined certification code to a user message generated by an originator and a second block for transmitting the certificated messages generated by the first block and the certification code used in generating the certificated message.

The receiving block includes a third block for receiving a certificated message from a server and a decrypting key for decrypting the prescribed certification code, a fourth block for decoding the user message from the received certificated message using the received decryption key, and a fifth block for displaying the decoded user message.

Another terminal according to a second or third embodiment of the present invention includes a transmitting block for certificating a message to transmit and a receiving block for receiving a message. The transmitting block includes a first block for granting a certification code to a user message generated by an originator and a second block for transmitting the certification code granted by the first block and the generated user message. For the transmission, the second block inserts the certification code in a reserved area of the user message to be transmitted.

The receiving block includes a third block for receiving a user message from the server and a verification result (phrase indicating that the user message certification code is valid or invalid) of validity for the user message certification code from the server, a fourth block for displaying the received verification result, and a fifth block for displaying the received user message in response to a request of a recipient. For the display, the fourth block detects the verification result inserted in the reserved area of the user message.

Meanwhile, each of the terminals according to the above-described embodiments of the present invention uses an identification code uniquely granted to the terminal or a terminal user as the certification code. For example, a social identification number of the terminal user may be used entirely or in part, or a digital electronic signature using a public key based certificate granted to the terminal or the terminal user may be used as the certification code.

According to another example of the present invention, once a user message or a certificated message is received from a prescribed originator to a prescribed called number, a server or relay side requests a certification code from a called side. In response to the request, the calling side sends a certification code entered in a code input window by the originator to the server or relay side. If so, the server or relay side verifies validity of the certification code received from the calling side. In doing so, the certification code request made by the server or relay side is repeated as many as a prescribed count by a prescribed time interval until a response (including the certification code) is received from the calling side.

In the above embodiments of the present invention, if the certification code of the certificated message is valid, it is preferable that the server or relay side sends a certification success message.

In addition, in the above embodiments of the present invention, in the case that the server or relay side does not send the verification result for the certification code of the certificated message to the receiving side is taken into consideration. Hence, the receiving side receives the corresponding message only if the server or relay side succeeds in the verification for the certification code of the certificated message. Otherwise, the receiving side does not receive any information for the verification result.

Moreover, in the above embodiments of the present invention, it is described that the message transmitted from the calling side is generated by the user via the prescribed menu. Yet, the message of the present invention preferably includes one multimedia (digital contents) selected by the user from various multimedia (various digital contents) previously stored in the calling side as well as the message generated by the user. Preferably, the message is selected by the user from messages previously stored in the calling side.

Hence, preferably, the aforesaid first menu is operative in selecting one of the previously stored messages or one of the previously stored multimedia (contents) to be included in the user message as well as in generating the message. As the first menu is provided, the calling terminal grants the certification code to the message generated or selected by means of the first menu.

Accordingly, the present invention provides the following effects or advantages. First, it can be certificated that the message sent by the calling side is valid or that the originator is a valid originator. Hence, without viewing the contents of a received message, the recipient can determine unnecessary or unlawful messages from the received messages.

Secondly, since the recipient can confirm whether a received message is sent from a valid originator or whether the received message is valid without checking the contents of the received message, the message transmission via the mobile communication service becomes more reliable.

Finally, the present invention is not limited to the message transmission function supported by the mobile communication system but is applicable to an e-mail transmission service via wire or wireless Internet with ease.

Throughout the description various functionality within the mobile terminals is discussed with regard to different menus for ease of explanation only. It should be understood that multiple functionally may be provided through a single interface menu.

It will be apparent to those skilled in the art that various modifications and variation can be made in the present invention without departing from the spirit or scope of the inventions. Thus, it is intended that the present invention cover the modifications and variations of this invention provided they come within the scope of the appended claims and their equivalents.

What is claimed is:

1. A method of certifying transmitted messages in a telecommunication system, the method comprising:
receiving a certificated message from a calling terminal, the certificated message including a certification code and a message;
determining whether the certification code is valid; and
relaying the message to a called terminal if the certification is determined to be valid.

2. The method of claim 1 further comprising:
receiving the message at the called terminal.

3. The method of claim 2 further comprising:
receiving the certification code with the message at the called terminal.

4. The method of claim 2 further comprising:
transmitting the certificated message from the calling terminal.

5. The method of claim 1, wherein a first server receives the certificated message from the calling terminal, and wherein a second server determines whether the certification code is valid.

6. The method of claim 1, wherein determining whether the certification code is valid comprises:
determining whether a code previously registered by the calling terminal matches the certification code.

7. The method of claim 1, wherein determining whether the certification code is valid comprises:
determining whether a code previously registered by the called party terminal matches the certification code.

8. The method of claim 1, wherein determining whether the certification code is valid comprises:
sending an inquiry to an online certificate status protocol (OCSP) unit; and
confirming the validity of the certification code based on a response to the inquiry from the online certificate status protocol (OCSP) responder.

9. The method of claim 1, wherein determining whether the certification code is valid comprises:
comparing the certification code to a list of codes stored in a certificate revocation list; and
determining the certification code is invalid if certification code is on the certificate revocation list.

10. The method of claim 9 further comprising:
placing the certification code on the certificate revocation list upon the expiration of a predetermined amount of time.

11. A method of certifying transmitted messages in a telecommunication system, the method comprising:
receiving a certificated message from a calling terminal, the certificated message including a certification code and a message;
relaying the certificated message to a called terminal;
determining whether the certification code is valid; and
revoking the certificated message if the certification code is determined to be invalid.

12. The method of claim 11, wherein determining whether the certification code is valid comprises:
determining whether a previously registered code matches the certification code.

13. The method of claim 11, wherein determining whether the certification code is valid comprises:
sending an inquiry to an online certificate status protocol (OCSP) unit; and
confirming the validity of the certification code based on a response to the inquiry from the online certificate status protocol (OCSP) responder.

14. The method of claim 11, wherein determining whether the certification code is valid comprises:
comparing the certification code to a list of codes stored in a certificate revocation list; and
determining the certification code is invalid if the certification code is on the certificate revocation list.

15. The method of claim 14 further comprising:
placing the certification code on the certificate revocation list upon the expiration of a predetermined amount of time.

16. A method of certifying transmitted messages in a telecommunication system, the method comprising:
receiving a certificated message from a calling terminal, the certificated message including a certification code and a message;
relaying the message to a called terminal;
determining whether the certification code is valid; and
sending a decryption key to the called terminal if the certification code is valid.

17. The method of claim 16 further comprising:
receiving the message at the called terminal; and
decrypting the message.

18. The method of claim 17 further comprising:
transmitting the certificated message from the calling terminal.

19. The method of claim 16, wherein determining whether the certification code is valid comprises:
determining whether a code previously registered by the calling terminal matches the certification code.

20. The method of claim 16, wherein determining whether the certification code is valid comprises:
determining whether a code previously registered by the called party terminal matches the certification code.

21. The method of claim 16, wherein determining whether the certification code is valid comprises:
sending an inquiry to an online certificate status protocol (OCSP) unit; and
confirming the validity of the certification code based on a response to the inquiry from the online certificate status protocol (OCSP) responder.

22. The method of claim 16, wherein determining whether the certification code is valid comprises:
comparing the certification code to a list of codes stored in a certificate revocation list; and
determining the certification code is invalid if certification code is on the certificate revocation list.

23. The method of claim 22 further comprising:
placing the certification code on the certificate revocation list upon the expiration of a predetermined amount of time.

24. The method of claim 16, wherein the message is provided by a communication service selected from a group of communication services consisting of a short message service, a long message service, an enhanced message service and a multimedia message service.

25. A method of certifying transmitted messages in a telecommunication system, the method comprising:
receiving a certificated message from a calling terminal, the certificated message including a certification code and a message;
relaying the certificated message to a called terminal;
determining whether the certification code is valid; and
transmitting a signal to the called terminal, the signal indicating whether or not the certification code is valid.

26. The method of claim 25 further comprising:
receiving at the called terminal the certificated message and the signal indicating whether or not the certification code is valid.

27. The method of claim 25, wherein determining whether the certification code is valid comprises:
determining whether a code previously registered by the calling terminal matches the certification code.

28. The method of claim 25, wherein determining whether the certification code is valid comprises:
determining whether a code previously registered by the called party terminal matches the certification code.

29. The method of claim 25, wherein determining whether the certification code is valid comprises:
sending an inquiry to an online certificate status protocol (OCSP) unit; and
confirming the validity of the certification code based on a response to the inquiry from the online certificate status protocol (OCSP) responder.

30. The method of claim 25, wherein determining whether the certification code is valid comprises:
comparing the certification code to a list of codes stored in a certificate revocation list; and
determining whether the certification code is invalid if certification code is on the certificate revocation list.

31. The method of claim 30 further comprising:
placing the certification code on the certificate revocation list upon the expiration of a predetermined amount of time.

32. A method of certifying transmitted messages in a telecommunication system, the method comprising:
receiving a message from a calling terminal;
requesting from the calling terminal a certification code for certifying the calling terminal;
receiving the certification code and determining whether or not the certification code is valid; and
relaying the message to a called terminal if the certification code is valid.

33. The method of claim 32, wherein determining whether the certification code is valid comprises:
determining whether a code previously registered by the calling terminal matches the certification code.

34. The method of claim 32, wherein determining whether the certification code is valid comprises:
determining whether a code previously registered by the called party terminal matches the certification code.

35. The method of claim 32, wherein determining whether the certification code is valid comprises:
sending an inquiry to an online certificate status protocol (OCSP) unit; and
confirming the validity of the certification code based on a response to the inquiry from the online certificate status protocol (OCSP) responder.

36. The method of claim 32, wherein determining whether the certification code is valid comprises:
comparing the certification code to a list of codes stored in a certificate revocation list; and
determining whether the certification code is invalid if certification code is in the certificate revocation list.

37. A telecommunication system for certifying transmitted messages, said system comprising:
first receiver receiving a certificated message from a calling terminal, the certificated message including a certification code and a message;
processor determining whether the certification code is valid; and
transmitter relaying the message to a called terminal if said processor determines that the certification code is valid.

38. The system of claim 37 further comprising:
second receiver at the called terminal, said second receiver receiving the transmitted message.

39. The system of claim 37 further comprising:
a first server which includes said first receiver.

40. The system of claim 39 further comprising:
a second server in communication with said first server, wherein said second server includes said processor.

41. The system of claim 37 further comprising:
memory storing a previously registered code.

42. The system of claim 37, wherein said processor determines whether the certification code is valid by sending an inquiry to an online certificate status protocol (OCSP) unit, and confirming the validity of the certification code based on a response to the inquiry from the online certificate status protocol (OCSP) responder.

43. In a telecommunication system, a server certifying transmitted messages, said server comprising:
means for receiving a certificated message from a calling terminal, the certificated message including a certification code and a message;
means for determining whether the certification code is valid; and
means for relaying the message to a called terminal if said processor determines that the certification code is valid.

44. The system of claim 43 further comprising:
means for storing a previously registered code.

45. The system of claim 44, wherein the certification code and the previously registered code are unique.

46. The system of claim 44, wherein said means for determining whether the certification code is valid comprises:
means for comparing the certification code to a list of previously stored codes; and
means for determining whether the certification code matches one of the previously stored codes.

47. The system of claim 44, wherein said means for determining whether the certification code is invalid comprises:
means for determining whether the certification code matches a previously stored code in a certificate revocation list.

48. The system of claim 43, wherein said means for determining whether the certification code is valid comprises:
means for sending an inquiry to an online certificate status protocol (OCSP) unit; and
means for confirming the validity of the certification code based on a response to the inquiry from the online certificate status protocol (OCSP) responder.

49. A telecommunication system for certifying transmitted messages, said system comprising:
receiver receiving a certificated message from a calling terminal, the certificated message including a certification code and a message;
transmitter relaying the certificated message to a called terminal;
processor determining whether the certification code is valid; and
means for revoking the certificated message if the certification code is determined to be invalid.

50. The system of claim 49 further comprising:
memory storing a previously registered code.

51. The system of claim 50, wherein the certification code and the previously registered code are unique.

52. The system of claim 50, wherein said processor determines whether the certification code is valid by comparing the certification code to a list of previously stored codes and by determining that the certification code matches one of the previously stored codes.

53. The system of claim 49, wherein said processor determines whether the certification code is valid by comparing the certification code to previously stored codes in a certificate revocation list.

54. The system of claim 49, wherein said processor determines whether the certification code is valid by sending an inquiry to an online certificate status protocol (OCSP) unit, and confirming the validity of the certification code based on a response to the inquiry from the online certificate status protocol (OCSP) responder.

55. A telecommunication system for certifying transmitted messages, said system comprising:
receiver receiving a certificated message from a calling terminal, the certificated message including a certification code and a message;
transmitter relaying the message to a called terminal; and
processor determining whether the certification code is valid, wherein said transmitter sends a decryption key to the called terminal if the certification code is valid.

56. The system of claim 55 further comprising:
second receiver at the called terminal receiving the message; and
second processor at the called terminal decrypting the message using the decryption key.

57. The system of claim 55 further comprising:
memory storing a previously registered code.

58. The system of claim 55, wherein said processor determines whether the certification code is valid by sending an inquiry to an online certificate status protocol (OCSP) unit, and confirming the validity of the certification code based on a response to the inquiry from the online certificate status protocol (OCSP) responder.

59. The system of claim 55, wherein said processor determines whether the certification code is valid by comparing the certification code to a list of codes stored in a certificate revocation list.

60. A telecommunication system for certifying transmitted messages, said system comprising:
receiver receiving a certificated message from a calling terminal, the certificated message including a certification code and a message;
transmitter relaying the certificated message to a called terminal; and
processor determining whether the certification code is valid, wherein a signal is sent to the called terminal indicating whether or not the certification code is valid.

61. The system of claim 60 further comprising:
second receiver at the called terminal receiving the message and the signal that indicates whether the certification code is valid.

62. The system of claim 60 further comprising:
memory storing a previously registered code.

63. The system of claim 60, wherein said processor determines whether the certification code is valid by sending an inquiry to an online certificate status protocol (OCSP) unit, and confirming the validity of the certification code based on a response to the inquiry from the online certificate status protocol (OCSP) responder.

64. The system of claim 60, wherein said processor determines whether the certification code is valid by comparing the certification code to a list of codes stored in a certificate revocation list.
